(19) United States
(12) Patent Application Publication
(10) Pub. No.: US 2021/0053265 A1
(43) Pub. Date: Feb. 25, 2021

(54) MOLD CLAMPING MECHANISM AND MOLD CLAMPING MECHANISM MANUFACTURING METHOD

(71) Applicant: FANUC CORPORATION, Yamanashi (JP)

(72) Inventors: Masatoshi SENGA, Yamanashi-ken (JP); Hiroaki KIRIHATA, Yamanashi-ken (JP)

(21) Appl. No.: 16/992,155

(22) Filed: Aug. 13, 2020

(30) Foreign Application Priority Data
Aug. 23, 2019 (JP) 2019-152700

(51) Int. Cl. B29C 45/66; B29C 45/83

(52) U.S. Cl. CPC B29C 45/661; B29C 2045/664; B29C 45/83

(57) ABSTRACT

A mold clamping mechanism includes a seal member for sealing in lubricant that has leaked from a through-hole, attached to a peripheral side surface of a tie bar exposed from the moving platen, and a housing that is separate from the moving platen, contacts a surface of the moving platen, and covers the tie bar, from the moving platen to the seal member, and the seal member.

### CROSS-REFERENCE TO RELATED APPLICATION

This application is based upon and claims the benefit of priority from Japanese Patent Application No. 2019-152700 filed on Aug. 23, 2019, the contents of which are incorporated herein by reference.

### BACKGROUND OF THE INVENTION

### Field of the Invention

The present invention relates to a mold clamping mechanism of an injection molding device and a mold clamping mechanism manufacturing method.

### Description of the Related Art

A mold clamping mechanism of an injection molding device includes a moving platen that can move in a mold clamping direction and a mold opening direction relative to a stationary platen, and a tie bar that is inserted through a through-hole formed in the moving platen.

Japanese Laid-Open Patent Publication No. 2001-246627 discloses a mold clamping mechanism in which a bearing that supports the tie bar is arranged inside the through-hole of the moving platen and an annular seal is arranged on an end surface of the moving platen.

### SUMMARY OF THE INVENTION

However, in the mold clamping mechanism of Japanese Laid-Open Patent Publication No. 2001-246627, there are cases where the tie bar becomes eccentric upward in a vertical direction relative to the through-hole of the moving platen, due to the load placed on the tie bar inserted through the through-hole of the moving platen. In such a case, the load placed on the seal from the tie bar becomes uneven, and there is a concern that this would cause problems such as damage to the seal.

Therefore, it is an object of the present invention to provide a mold clamping mechanism and a mold clamping mechanism manufacturing method that can strengthen the sealing capability even when the tie bar is eccentric relative to the through-hole of the moving platen.

One aspect of the present invention is:

a mold clamping mechanism of an injection molding device that includes a moving platen that is movable in a mold clamping direction and a mold opening direction, relative to a stationary platen, and a tie bar that is inserted through a through-hole formed in the moving platen, the mold clamping mechanism including:

a seal member configured to seal in lubricant that has leaked from the through-hole, and attached to a peripheral side surface of the tie bar exposed from the moving platen; and

a housing that is separate from the moving platen, the housing configured to contact a surface of the moving platen and cover the tie bar, from the moving platen to the seal member, and the seal member.

Another aspect of the present invention is:

a mold clamping mechanism manufacturing method for manufacturing a mold clamping mechanism of an injection molding device, including:

an insertion step of inserting a tie bar through a through-hole formed in a moving platen that is movable in a mold clamping direction and a mold opening direction; and

an assembling step of assembling a seal structure on the tie bar, wherein

the seal structure includes:

a seal member configured to seal in lubricant that has leaked from the through-hole, and attached to a peripheral side surface of the tie bar exposed from the moving platen, and

a housing that is separate from the moving platen, the housing configured to contact a surface of the moving platen, and cover the tie bar, from the moving platen to the seal member, and the seal member.

According to the aspects of the present invention, even when the tie bar is eccentric relative to the through-hole of the moving platen, the seal structure can be provided in a manner not to become eccentric relative to the moving platen. Accordingly, it is possible to provide a mold clamping mechanism and a mold clamping mechanism manufacturing method that can strengthen the sealing capability even when the tie bar is eccentric relative to the through-hole of the moving platen.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a side view of a mold clamping mechanism;

FIG. 2 is a perspective view of the mold clamping mechanism that includes a seal structure of a first embodiment;

FIG. 3 is a cross-sectional view of the seal structure of the first embodiment;

FIG. 4 is a cross-sectional view of a seal structure of a second embodiment;

FIG. 5 is a cross-sectional view of a seal structure of a first modification; and

FIG. 6 is a cross-sectional view of a seal structure of a second modification.

### DESCRIPTION OF THE PREFERRED EMBODIMENTS

The following describes in detail preferred embodiments of the present invention, while referencing the accompanying drawings. Each direction mentioned in the description below conforms to the arrows shown in each drawing.

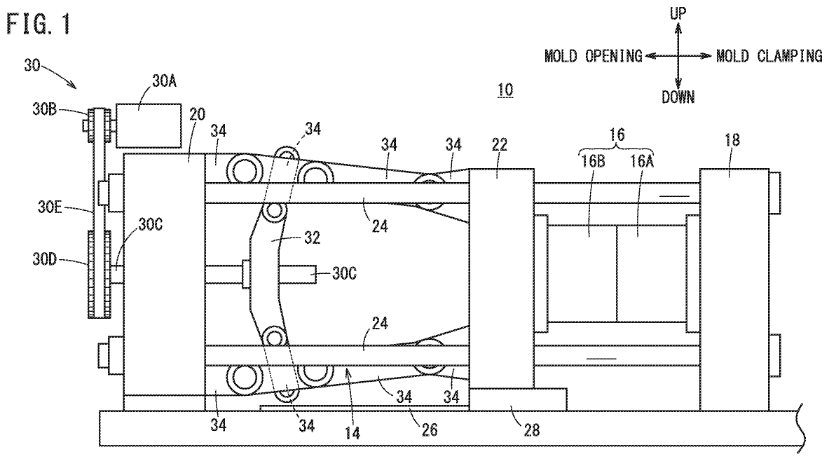

The following describes a mold clamping mechanism 10 included in an injection molding device, using FIG. 1. The mold clamping mechanism 10 includes a mold 16, a stationary platen 18, a rear platen 20, and a moving platen 22.

The mold 16 includes a fixed mold piece 16A and a movable mold piece 16B that is capable of moving in a mold clamping direction and a mold opening direction relative to the fixed mold piece 16A. The fixed mold piece 16A is attached to the stationary platen 18, and the movable mold piece 16B is attached to the moving platen 22.

The stationary platen 18 and the rear platen 20 are arranged on a machine base of the injection molding device with a space between these platens, and are connected by a plurality of tie bars 24 that extend in the mold clamping direction and the mold opening direction.

The moving platen 22 is arranged between the stationary platen 18 and the rear platen 20. The plurality of tie bars 24 each slidably penetrate through the moving platen 22. Furthermore, the moving platen 22 is provided with a slide portion 28 that fits into a guide rail 26. The guide rail 26 extends in the mold clamping direction and the mold opening direction. Accordingly, the moving platen 22 is capable of moving in both the mold clamping direction and the mold opening direction relative to the stationary platen 18, by being guided by the plurality of tie bars 24 and the guide rail 26.

The mold clamping mechanism 10 includes a platen driving section 30, a cross head 32, and toggle links 34.

The platen driving section 30 includes a motor 30A, a drive pulley 30B connected to the motor 30A, a ball screw 30C attached to the rear platen 20, a driven pulley 30D connected to the ball screw 30C, and a belt 30E provided to the drive pulley 30B and the driven pulley 30D.

In the platen driving section 30, when the drive pulley 30B rotates in response to rotation of the motor 30A, the driven pulley 30D and the ball screw 30C rotate integrally due to the belt 30E. The shaft of the ball screw 30C extends in the mold clamping direction and the mold opening direction. The cross head 32 is provided to a nut (not shown in the drawing) that is screwed onto the ball screw 30C. Accordingly, when the ball screw 30C rotates forward (or rotates backward) in response to a mold clamping operation, the cross head 32 moves in the mold clamping direction. On the other hand, when the ball screw 30C rotates backward (or rotates forward) in response to a mold opening operation, the cross head 32 moves in the mold opening direction.

The cross head 32 is connected to the moving platen 22, via the plurality of toggle links 34. Accordingly, when the cross head 32 moves in the mold clamping direction, the moving platen 22 is pushed by the cross head 32, via the plurality of toggle links 34, to move in the mold clamping direction.

When the moving platen 22 moves in the mold clamping direction, the movable mold piece 16B attached to the moving platen 22 moves in the mold clamping direction in accordance with this movement. When the movable mold piece 16B contacts the fixed mold piece 16A, a cavity to be filled with a molding material injected from an injection mechanism (not shown in the drawings) is formed in the mold 16.

On the other hand, when the cross head 32 moves in the mold opening direction, the moving platen 22 is pulled by the cross head 32, via the plurality of toggle links 34, to move in the mold opening direction.

When the moving platen 22 moves in the mold opening direction, the movable mold piece 16B attached to the moving platen 22 moves in the mold opening direction in accordance with this movement. When the movable mold piece 16B has moved to a position that is a prescribed space from the fixed mold piece 16A, the cavity of the mold 16 can be filled and a hardened molded product (a hardened molding) can be extracted.

### First Embodiment

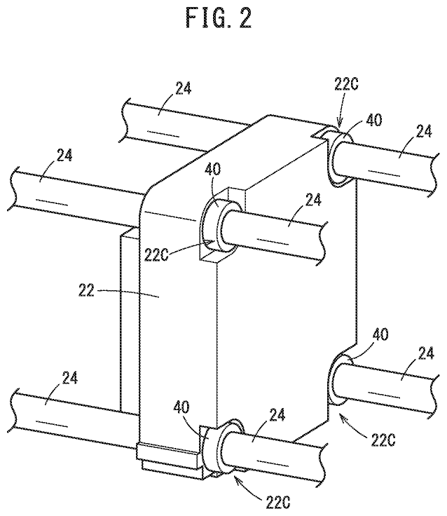

The following describes a seal structure 40 of the first embodiment included in the mold clamping mechanism 10 with reference to FIG. 2. In FIG. 2, the moving platen 22 and the tie bars 24 of the mold clamping mechanism 10 are shown, but the movable mold piece 16B is omitted.

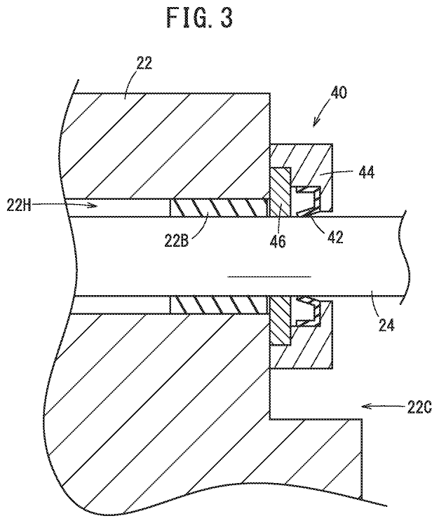

The seal structure 40 is provided for each of the plurality of tie bars 24. In FIG. 2, an example is shown of a case in which the number of tie bars 24 is four. Each seal structure 40 provided to a corresponding one of the plurality of tie bars 24 has the same structure. The following is a detailed description of only one seal structure 40, using FIG. 3.

A through-hole 22H through which the tie bar 24 is inserted is formed in the moving platen 22, and a tube-shaped bush 22B is fixed in the through-hole 22H. The tie bar 24 inserted into the through-hole 22H passes through the bush 22B, and a lubricant is provided in the space between the bush 22B and the tie bar 24.

The seal structure 40 is a structure that seals in the lubricant that has leaked outside the moving platen 22, and includes a seal member 42, a housing 44, and a covering member 46.

The seal member 42 is a member for sealing in the lubricant that has leaked from the through-hole 22H of the moving platen 22 (the space between the bush 22B and the tie bar 24). The seal member 42 is attached to a peripheral side surface of the tie bar 24 exposed from the moving platen 22. The seal member 42 may be attached to the peripheral side surface of the tie bar 24 exposed from the moving platen 22 on the stationary platen 18 side, or may be attached to the peripheral side surface of the tie bar 24 exposed on the side opposite to the stationary platen 18 side. The seal member 42 is formed by a waterproof material, such as rubber. The seal member 42 may be an O-ring.

The housing 44 contacts the surface of the moving platen 22, and covers the tie bar 24, from the moving platen 22 to the seal member 42, and the seal member 42. The housing 44 is separate from the moving platen 22, and is fixed to the moving platen 22 in the present embodiment.

A recessed portion 22C is formed in the surface of an end portion of the moving platen 22 on the side in the direction in which the tie bar 24 extends, and the housing 44 may be housed inside this recessed portion 22C. The recessed portion 22C may be formed in the surface of the end portion of the moving platen 22 on the stationary platen 18 side in the direction in which the tie bar 24 extends, or may be formed in the surface of the end portion of the moving platen 22 on the side opposite to the stationary platen 18. The surface of the end portion of the moving platen 22 on the stationary platen 18 side in the direction in which the tie bar 24 extends is a mold surface on which the movable mold piece 16B is arranged.

The covering member 46 is housed in the housing 44, and is arranged closer to the moving platen 22 than the seal member 42 is (the covering member 46 is arranged on or near the side of the seal member 42 toward the moving platen 22 side). The covering member 46 covers the peripheral side surface of the tie bar 24, and is slidable relative to the tie bar 24. By providing the covering member 46, it becomes easy to increase the slidability of the moving platen 22 while suppressing positional skewing of the housing 44 relative to the tie bar 24.

The covering member 46 may be formed of a material with a relatively low friction coefficient and having lubricity, such as PTFE (polytetrafluoroethylene).

The space between the covering member 46 and the tie bar 24 may be smaller than the space between the bush 22B and the tie bar 24. If the space between the covering member 46 and the tie bar 24 is smaller than the space between the bush 22B and the tie bar 24, it becomes easy to restrict the covering member 46 from becoming eccentric relative to the tie bar 24. It should be noted that the covering member 46 may be omitted.

The following describes a portion of the mold clamping mechanism 10 manufacturing method for manufacturing the mold clamping mechanism 10 of the injection molding device. Specifically, steps for assembling the seal structure 40 described above in the mold clamping mechanism 10 manufacturing method are described.

In the mold clamping mechanism 10 manufacturing method, when assembling the seal structure 40, first, an insertion step of inserting the tie bar 24 through the through-hole 22H formed in the moving platen 22 is performed. When this insertion step is finished, the tie bar 24 is eccentric upward in the vertical direction relative to the through-hole 22H of the moving platen 22, due to the load placed on the tie bar 24.

After the insertion step is finished, an assembly step of assembling the seal structure 40 described above on the tie bar 24 exposed from the moving platen 22 is performed. Essentially, the seal member 42, the housing 44, and the covering member 46 of the seal structure 40 are provided in a prescribed order relative to the tie bar 24 inserted through the through-hole 22H of the moving platen 22. For example, the housing 44 is provided after the covering member 46 has been provided to the tie bar 24 inserted through the through-hole 22H of the moving platen 22, and the seal member 42 is provided in the space between the housing 44 and the tie bar 24.

In this way, after the tie bar 24 is inserted through the through-hole 22H of the moving platen 22, the seal structure 40 is assembled on the tie bar 24 exposed from the moving platen 22. Therefore, even when the tie bar 24 is eccentric relative to the through-hole 22H of the moving platen 22, the seal structure 40 can be provided without being eccentric relative to the tie bar 24.

Accordingly, even when the tie bar 24 is eccentric relative to the through-hole 22H of the moving platen 22, the seal structure 40 prevents leakage of the lubricant and prevents damage caused by this eccentricity. As a result, even when the tie bar 24 is eccentric relative to the through-hole 22H of the moving platen 22, the sealing capability can be strengthened.

### Second Embodiment

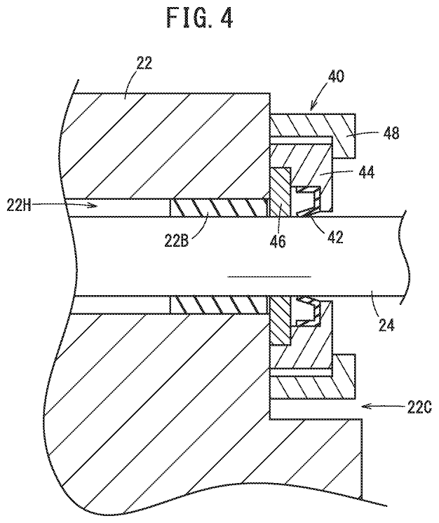

The following describes a seal structure 40 of the second embodiment included in the mold clamping mechanism 10, using FIG. 4. In FIG. 4, configurations that are equivalent to configurations described above in the first embodiment are denoted by the same reference numerals. In the present embodiment, descriptions that overlap with those of the first embodiment above are omitted.

In the present embodiment, the seal structure 40 includes an attaching member 48 in addition to the seal member 42, the housing 44, and the covering member 46.

The housing 44 is not fixed to the moving platen 22 in the present embodiment, in contrast to the housing 44 being fixed to the moving platen 22 in the first embodiment. In other words, in the present embodiment, the housing 44 contacts the surface of the moving platen 22 without being fixed to the moving platen 22.

The attaching member 48 attaches the housing 44 to the moving platen 22 in a manner to restrict movement of the housing 44 in the direction in which the tie bar 24 extends and to allow the housing 44 to move in a direction intersecting the direction in which the tie bar 24 extends. The attaching member 48 is fixed to the moving platen 22.

The attaching member 48 may cover the housing 44, and may press the housing 44 against the moving platen 22.

In the present embodiment, the seal member 42 and the housing 44 are provided to be capable of moving in a direction intersecting with the extension direction of the tie bar 24, relative to the tie bar 24 exposed from the moving platen 22. Therefore, even when the tie bar 24 is eccentric relative to the through-hole 22H of the moving platen 22, the seal member 42 and the housing 44 follow the tie bar 24 in a manner not to become eccentric relative to the tie bar 24.

Accordingly, even when the tie bar 24 is eccentric relative to the through-hole 22H of the moving platen 22, the seal structure 40 of the present embodiment prevents leakage of the lubricant and prevents damage caused by this eccentricity, in the same manner as in the first embodiment. As a result, even when the tie bar 24 is eccentric relative to the through-hole 22H of the moving platen 22, the sealing capability can be strengthened.

### [Modifications]

The embodiments described above may be modified as described below.

### (First Modification)

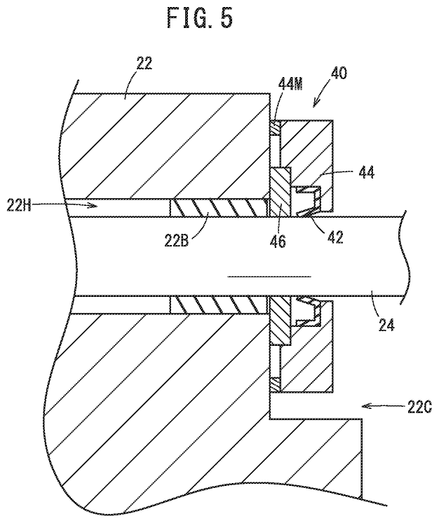

The following describes a seal structure 40 of the first modification, using FIG. 5. In FIG. 5, configurations that are equivalent to configurations described above in the first embodiment are denoted by the same reference numerals. In the first modification, descriptions that overlap with those of the first embodiment above are omitted.

The seal structure 40 of the first modification is a modification of the seal structure 40 of the first embodiment. In the seal structure 40 of the first modification, the housing 44 includes a magnet 44M and is fixed to the moving platen 22, which is metal, by the magnetic force of the magnet 44M. The magnet 44M may be included at least in the end portion of the moving platen 22 on the side in the direction in which the tie bar 24 extends, instead of in the housing 44. In a case where the magnet 44M is included on the moving platen 22 side, the housing 44 is formed of metal.

In other words, in the seal structure 40 of the first modification, the housing 44 is fixed to the moving platen 22 by magnetic force. Therefore, when the friction resistance with respect to the tie bar 24 becomes greater than the magnetic force, the housing 44 can be automatically released from the state of being fixed to the moving platen 22 when the moving platen 22 moves. Furthermore, the housing 44 can notify an operator that the friction resistance with respect to the tie bar 24 has become greater than the magnetic force, through the automatic release of the housing 44 that was fixed to the moving platen 22.

When the friction resistance with respect to the tie bar 24 becomes greater than the magnetic force, there are cases where dust that has entered into the housing 44 from outside remains in the space between the covering member 46 and the tie bar 24.

### (Second Modification)

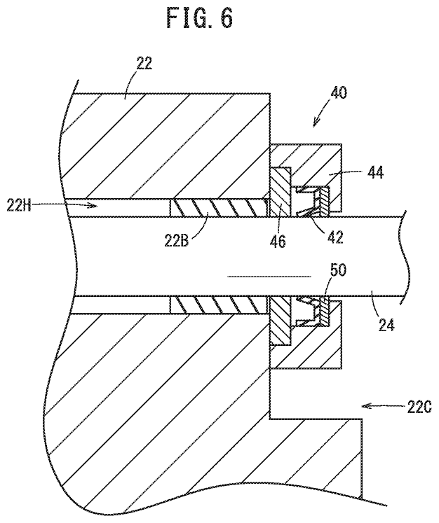

The following describes a seal structure 40 of the second modification, using FIG. 6. In FIG. 6, configurations that are equivalent to configurations described above in the first embodiment are denoted by the same reference numerals. In the second modification, descriptions that overlap with those of the first embodiment above are omitted.

The seal structure 40 of the second modification is a modification of the seal structure 40 of the first embodiment. The seal structure 40 of the second modification further includes a fiber member 50 for closing the space between the tie bar 24 and the housing 44. The fiber member 50 is housed in the housing 44, and is arranged farther from the moving platen 22 than the seal member 42 is (the fiber member 50 is arranged on or near the side of the seal member 42 opposite to the moving platen 22 side). By including such a fiber member 50, it is possible to suppress the entrance of dust into the housing 44 from the outside.

The fiber member 50 may also be included in the seal structure 40 of the second embodiment.

[Invention Obtainable from the Above Description]

The following is a record of the invention that can be understood from the embodiments and modifications described above.

### (First Aspect)

The first aspect of the present invention is:

the mold clamping mechanism (10) of the injection molding device that includes the moving platen (22) that is movable in a mold clamping direction and a mold opening direction, relative to the stationary platen (18), and the tie bar (24) that is inserted through the through-hole (22H) formed in the moving platen (22), the mold clamping mechanism (10) including:

the seal member (42) configured to seal in lubricant that has leaked from the through-hole (22H), and attached to a peripheral side surface of the tie bar (24) exposed from the moving platen (22); and

the housing (44) that is separate from the moving platen (22), the housing (44) configured to contact a surface of the moving platen (22), and cover the tie bar (24), from the moving platen (22) to the seal member (42), and the seal member (42).

In this way, even when the tie bar (24) is eccentric relative to the through-hole (22H) of the moving platen (22), the seal structure (40) can be provided in a manner not to be eccentric relative to the tie bar (24). Accordingly, even when the tie bar (24) is eccentric relative to the through-hole (22H) of the moving platen (22), the seal structure (40) prevents leakage of the lubricant and prevents damage caused by this eccentricity. As a result, even when the tie bar (24) is eccentric relative to the through-hole (22H) of the moving platen (22), it is possible to strengthen the sealing capability.

The housing (44) may be fixed to the moving platen (22). In this way, it is possible to strengthen the sealing capability of the seal structure (40).

The housing (44) may be fixed to the moving platen (22) by magnetic force. In this way, when the friction resistance with respect to the tie bar (24) becomes greater than the magnetic force, it is possible to automatically release the housing (44) from being fixed to the moving platen (22) when the moving platen (22) moves.

The housing (44) does not need to be fixed to the moving platen (22), and the mold clamping mechanism (10) may include the attaching member (48) configured to attach the housing to the moving platen so as to restrict movement of the housing (44) in the direction in which the tie bar (24) extends and allow movement of the housing (44) in a direction that intersects with the direction in which the tie bar (24) extends. In this way, even when the tie bar (24) is eccentric relative to the through-hole (22H) of the moving platen (22), the seal member (42) and the housing (44) follow the tie bar (24) in a manner not to become eccentric relative to the tie bar (24). Accordingly, even when the tie bar (24) is eccentric relative to the through-hole (22H) of the moving platen (22), it is possible to strengthen the sealing capability.

The recessed portion (22C) may be formed in the outer surface of the moving platen (22) on the stationary platen (18) side, and the housing (44) may be housed inside the recessed portion (22C). In this way, the housing (44) can be prevented from interfering when the movable mold piece (16B) is arranged on the outer surface of the moving platen (22) on the stationary platen 18 side.

The mold clamping mechanism (10) may include the fiber member (50) that is housed in the housing (44), arranged farther from the moving platen (22) than the seal member (42) is, and configured to close a space between the tie bar (24) and the housing (44). In this way, dust can be prevented from entering inside the housing (44) from the outside.

The mold clamping mechanism (10) may include the covering member (46) that is housed in the housing (44), is arranged closer to the moving platen (22) than the seal member (42) is, and configured to cover a peripheral side surface of the tie bar (24) while being slidable relative to the tie bar (24). In this way, it becomes easy to increase the slidability of the moving platen (22) while restricting positional skewing of the housing (44) relative to the tie bar (24).

The space between the covering member (46) and the tie bar (24) may be smaller than a space between a tube-shaped bush (22B) fixed to the through-hole (22H) and the tie bar (24) inserted through the bush (22B). In this way, it is easy to suppress the eccentricity of the covering member (46) relative to the tie bar (24).

### (Second Aspect)

The second aspect of the present invention is the mold clamping mechanism (10) manufacturing method for manufacturing the mold clamping mechanism (10) of the injection molding device, including:

an insertion step of inserting the tie bar (24) through the through-hole (22H) formed in the moving platen (22) that is movable in the mold clamping direction and the mold opening direction; and

an assembling step of assembling the seal structure (40) on the tie bar (24), wherein

the seal structure (40) includes the seal member (42) configured to seal in lubricant that has leaked from the through-hole (22H), and attached to a peripheral side surface of the tie bar (24) exposed from the moving platen (22), and the housing (44) that is separate from the moving platen (22), the housing configured to contact a surface of the moving platen (22), and cover the tie bar (24), from the moving platen (22) to the seal member (42), and the seal member (42).

In this way, even when the tie bar (24) is eccentric relative to the through-hole (22H) of the moving platen (22), the seal structure (40) can be provided in a manner not to be eccentric relative to the tie bar (24). Accordingly, even when the tie bar (24) is eccentric relative to the through-hole (22H) of the moving platen (22), the seal structure (40) prevents leakage of the lubricant and prevents damage caused by this eccentricity. As a result, even when the tie bar (24) is eccentric relative to the through-hole (22H) of the moving platen (22), it is possible to strengthen the sealing capability.

The present invention is not limited to the embodiments described above, and it goes without saying that the embodiments can be freely modified within a range that does not deviate from the essence and gist of the present invention as set forth in the appended claims.

1. A mold clamping mechanism of an injection molding device that includes a moving platen that is movable in a mold clamping direction and a mold opening direction, relative to a stationary platen, and a tie bar that is inserted through a through-hole formed in the moving platen, the mold clamping mechanism comprising:
a seal member configured to seal in lubricant that has leaked from the through-hole, and attached to a peripheral side surface of the tie bar exposed from the moving platen; and
a housing that is separate from the moving platen, the housing configured to contact a surface of the moving platen and cover the tie bar, from the moving platen to the seal member, and the seal member.

2. The mold clamping mechanism according to claim 1, wherein the housing is fixed to the moving platen.

3. The mold clamping mechanism according to claim 1, wherein the housing is fixed to the moving platen by magnetic force.

4. The mold clamping mechanism according to claim 1, wherein the housing is not fixed to the moving platen, and
the mold clamping mechanism comprises an attaching member configured to attach the housing to the moving platen so as to restrict movement of the housing in a direction in which the tie bar extends and allow movement of the housing in a direction that intersects with the direction in which the tie bar extends.

5. The mold clamping mechanism according to claim 1, wherein a recessed portion is formed in an outer surface of the moving platen on the stationary platen side, and
the housing is housed inside the recessed portion.

6. The mold clamping mechanism according to claim 1, comprising a fiber member that is housed in the housing, arranged farther from the moving platen than the seal member is, and configured to close a space between the tie bar and the housing.

7. The mold clamping mechanism according to claim 1, comprising a covering member that is housed in the housing, arranged closer to the moving platen than the seal member is, and configured to cover a peripheral side surface of the tie bar while being slidable relative to the tie bar.

8. The mold clamping mechanism according to claim 7, wherein a space between the covering member and the tie bar is smaller than a space between a tube-shaped bush fixed to the through-hole and the tie bar inserted through the bush.

9. A mold clamping mechanism manufacturing method for manufacturing a mold clamping mechanism of an injection molding device, comprising:
an insertion step of inserting a tie bar through a through-hole formed in a moving platen that is movable in a mold clamping direction and a mold opening direction; and
an assembling step of assembling a seal structure on the tie bar, wherein
the seal structure includes:
a seal member configured to seal in lubricant that has leaked from the through-hole, and attached to a peripheral side surface of the tie bar exposed from the moving platen; and
a housing that is separate from the moving platen, the housing configured to contact a surface of the moving platen and cover the tie bar, from the moving platen to the seal member, and the seal member.
